(19) United States
(12) Patent Application Publication
(10) Pub. No.: US 2015/0120772 A1
(43) Pub. Date: Apr. 30, 2015

(54) METHOD AND SYSTEM FOR INFORMATION PUSH

(71) Applicant: TENCENT TECHNOLOGY (SHENZHEN) COMPANY LIMITED, Guangdong (CN)

(72) Inventors: Xinyu Cui, Guangdong (CN); Dong Xie, Guangdong (CN); Xu Wang, Guangdong (CN); Yuhang Zhou, Guangdong (CN)

(73) Assignee: TENCENT TECHNOLOGY (SHENZHEN) COMPANY LIMITED, Guangdong (CN)

(21) Appl. No.: 14/591,967

(22) Filed: Jan. 8, 2015

Related U.S. Application Data
(63) Continuation of application No. PCT/CN2014/078019, filed on May 21, 2014.

(30) Foreign Application Priority Data
May 21, 2013 (CN) 201310196401.4

(51) Int. Cl. G06F 17/30

(52) U.S. Cl. CPC G06F 17/30386; G06Q 30/0625
USPC 707/758

(57) ABSTRACT

A method and a system for information push are described, the method including: receiving a business search command determined by an operation of a user; responding the business search command, and sending a business search request which comprises current location information of the user to a first server to query a business matching the current location information of the user; and receiving information of the business in response to the business search request returned by the first server. Product information can be accurately pushed to a user. In addition, a real-time update for the product information can be made by a business, and the push effect of the product information can be improved.

### CROSS REFERENCE TO RELATED APPLICATIONS

This application is a continuation application of PCT Patent Application No. PCT/CN2014/078019, entitled “METHOD AND SYSTEM FOR INFORMATION PUSH”, filed on May 21, 2014, which claims priority to Chinese Patent Application No. 201310196401.4, entitled “METHOD AND SYSTEM FOR INFORMATION PUSH” and filed on May 21, 2013, both of which are hereby incorporated in their entireties by reference.

### FIELD

The disclosure relates to Internet technology field, and to a method and a system for information push.

### BACKGROUND

This section provides background information related to the present disclosure which is not necessarily prior art.

With the growing number of mobile phone users, more and more merchants, to achieve the purpose of low-cost product information pushing, have begun to push the product information to mobile phone users by the aid of a cloud server. However, pushing product information to mobile phone users by the cloud server is a very blind way for information push. Because the product information is indistinguishably pushed to all mobile phone users by the cloud server, the users may not found exactly. In addition, as a kind of public server, the cloud server has lots of restrictions, so that a real-time update for the product information is unable made by the merchants, thereby leading to a poor push effect for the product information.

### SUMMARY

This section provides a general summary of the disclosure, and is not a comprehensive disclosure of its full scope or all of its features.

In a method and a system for information push according to various embodiments of the invention, product information can be accurately pushed to a user. In addition, a real-time update for the product information can be made by a merchant, and a push effect of the product information can be improved.

According to a first aspect of the present invention, it is provided a method for information push, including:

receiving a business search command determined by an operation of a user;

responding the business search command, and sending a business search request which comprises current location information of the user to a first server to query a business matching the current location information of the user; and

receiving information of the business in response to the business search request returned by the first server

According to a second aspect of the present invention, it is provided a terminal, including:

memory;

one or more processors; and

one or more modules stored in the memory and configured for execution by the one or more processors, the one or more modules including instructions:

to receive a business search command determined by an operation of a user;

to respond the business search command received by the first receiving module, and send a business search request which comprises current location information of the user to a first server to query a business matching the current location information of the user;

to receive information of the business in response to the business search request returned by the first server.

According to a third aspect of the present invention, it is provided a system for information push, including a terminal, a first server and a second server, wherein

the terminal is configured to receive a business search command determined by an operation of a user, respond the business search command, and send a business search request which comprises current location information of the user to a first server;

the first server is configured to query a business matching the current location information of the user after receiving the business search request, and send a server address of the business to the terminal;

the terminal is further configured to respond an operation which is aimed at the server address of the business by the user after receiving the server address of the business sent by the first server, sending an information push request to a second server corresponding to the business, wherein the second server is configured to store product information customized by the business; and

the second server is configured to respond the information push request, and push the product information customized by the business to the terminal.

According to a fourth aspect of the present invention, it is provided a computer readable storage medium for storing computer and/or mobile terminal executable program, wherein the executable program is used for controlling the computer and/or mobile terminal to perform a method for information push, including:

receiving a business search command determined by an operation of a user;

responding the business search command, and sending a business search request which comprises current location information of the user to a first server to query a business matching the current location information of the user; and

receiving information of the business in response to the business search request returned by the first server.

In various embodiments of the present invention, a terminal can respond a business search command and send a business search request which includes current location information of a user after receiving the business search command determined by an operation of the user. So that a first server can query a business matching the current location information of the user, and send a server address of the business to the terminal after receiving the business search request. After receiving the server address of the business sent by the first server, the terminal can respond an operation which is aimed at the server address of the business by the user, and send an information push request to a second server corresponding to the business. The second server can respond the information push request, and push the product information customized by the business to the terminal. In various embodiments of the present invention, it is obvious that product information can be accurately pushed to a user. In addition, the second server, which stores the product information customized by the business, belongs to a private server. So that the business can set up its own product information and make a real-time update for the product information, thereby improving the push effect of the product information.

### BRIEF DESCRIPTION OF THE DRAWINGS

In order to illustrate the embodiments or existing technical solutions more clearly, a brief description of drawings that assists the description of embodiments of the invention or existing art will be provided below. It would be apparent that the drawings in the following description are only for some of the embodiments of the invention. A person having ordinary skills in the art will be able to obtain other drawings on the basis of these drawings without paying any creative work.

FIG. 1 is a flowchart of a method for information push disclosed by one embodiment of the present invention.

FIG. 2 is a flowchart of a method for information push disclosed by another embodiment of the present invention.

FIG. 3 is a structure diagram of a system for information push disclosed by one embodiment of the present invention.

FIG. 4 is a structure diagram of a system for information push disclosed by another embodiment of the present invention.

FIG. 5 is a structure diagram of a terminal disclosed by one embodiment of the present invention.

FIG. 6 depicts an exemplary environment incorporating certain disclosed embodiments;

FIG. 7 depicts an exemplary computing system consistent with the disclosed embodiments.

### DETAILED DESCRIPTION OF ILLUSTRATED EMBODIMENTS

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

FIG. 6 depicts an exemplary environment 600 incorporating exemplary methods and systems for information push in accordance with various disclosed embodiments. As shown in FIG. 6, the environment 600 can include a server 602, a terminal 604, and a communication network 606. The server 602 and the terminal 604 may be coupled through the communication network 606 for information exchange including, e.g., sending/receiving business search commands, response information, etc. Although only one terminal 604 and one server 602 are shown in the environment 600, any number of terminals 604 or servers 602 may be included, and other devices may also be included. Particularly, the server 602 may include a plurality of servers, and one or more of them are used to construct the system for information push and implement the method for information push as disclosed in various embodiments below.

The communication network 606 may include any appropriate type of communication network for providing network connections to the server 602 and terminal 604 or among multiple servers 602 or terminals 604. For example, the communication network 606 may include the Internet or other types of computer networks or telecommunication networks, either wired or wireless.

A terminal, as used herein, may refer to any appropriate user terminal with certain computing capabilities, e.g., a personal computer (PC), a work station computer, a hand-held computing device (e.g., a tablet), a mobile terminal (e.g., a mobile phone or a smart phone), or any other client-side computing device.

A server, as used herein, may refer to one or more server computers configured to provide certain server functionalities, e.g., providing business querying services, receiving business search commands, pushing information, etc. A server may also include one or more processors to execute computer programs in parallel.

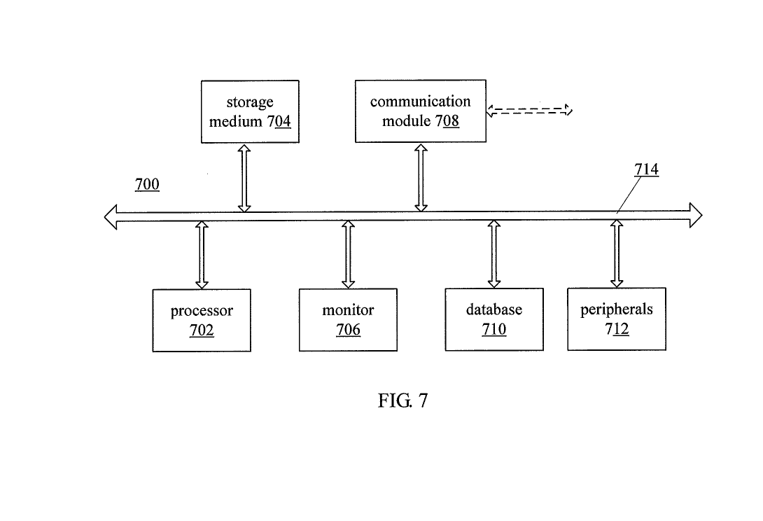

The system and the method for information push as disclosed in various embodiments below may be implemented on any appropriate computing platform. FIG. 7 shows a block diagram of an exemplary computing system 700 (or computer system 700) capable of implementing the system and the method for information push. The computing system 700 may run in the server 602 that is shown in FIG. 6. As shown in FIG. 7, the exemplary computer system 700 may include a processor 702, a storage medium 704, a monitor 706, a communication module 708, a database 710, peripherals 712, and one or more bus 714 to couple the devices together. Certain devices may be omitted and other devices may be included.

The processor 702 can include any appropriate processor or processors. Further, the processor 702 can include multiple cores for multi-thread or parallel processing. The storage medium 704 may include memory modules, e.g., Read-Only Memory (ROM), Random Access Memory (RAM), and flash memory modules, and mass storages, e.g., CD-ROM, U-disk, removable hard disk, etc. The storage medium 704 may store computer programs for implementing various processes (e.g., querying business information, responding commands, etc.), when executed by the processor 702.

The monitor 706 may include display devices for displaying contents in the computing system 700, e.g., displaying input information, business information, etc. The peripherals 712 may include I/O devices such as keyboard and mouse.

Further, the communication module 708 may include network devices for establishing connections through the communication network 606. The database 710 may include one or more databases for storing certain data and for performing certain operations on the stored data, e.g., storing business search commands, storing business information, searching and management operations.

Various embodiments provide methods and systems for information push. The methods and systems are illustrated in various examples described herein.

In a method and a system for information push according to various embodiment of the invention, product information can be accurately pushed to a user. In addition, a real-time update for the product information can be made by a business, and the push effect of the product information can be improved, which will be described in detail below.

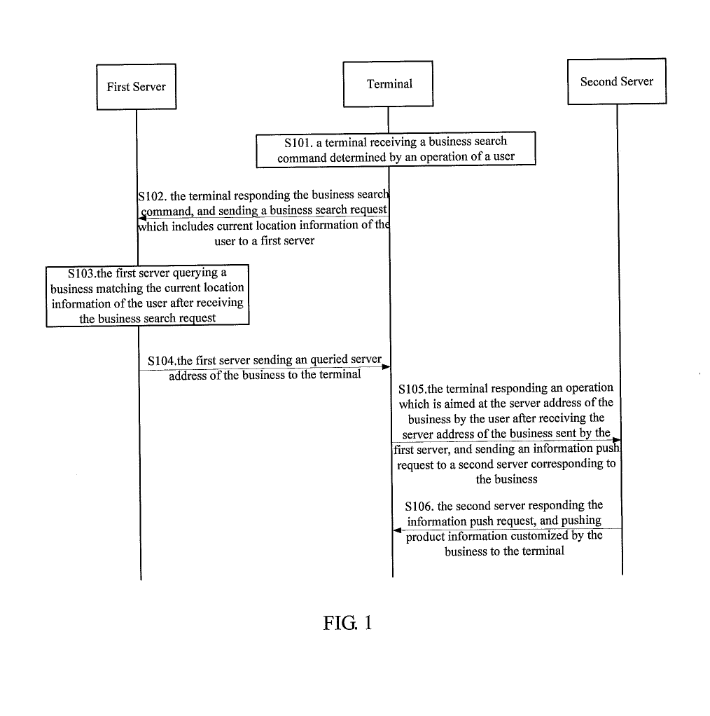

Referring to FIG. 1, it is a flowchart of a method for information push disclosed by one embodiment of the present invention. As shown in FIG. 1, the method for information push may include the following steps.

Step S101, a terminal receiving a business search command determined by an operation of a user.

In one embodiment of the present invention, the terminal may be a smart phone (such as an Android phone, an iOS mobile phone, etc), a tablet computer, a handheld computer, a mobile internet device (Mobile Internet Device, MID) or other mobile terminal, and can also be a PC, which will not be restricted in embodiments of the present invention.

In one embodiment, the terminal can receive the business search command input by the user when operating a business search interface on an instant messaging tool, such as a business search interface on a business search plugin or some other information platforms. Specifically, the user can click to enter a plugin interface of the instant messaging tool after using an instant messaging account to login the instant messaging tool on the terminal. Furthermore, the user may single-click or double-click the business search plugin on the plugin interface of the instant messaging tool, thereby triggering to input a business search command to the terminal. Embodiments of the present invention can be combined with massive users in the instant messaging tool, business information around a user can be provided for the user in the instant messaging tool, and at the same time, a product push channel with low-cost but high-precision will be provided for the businesses.

Step S102, the terminal responding the business search command, and sending a business search request which includes current location information of the user to a first server.

In one embodiment of the present invention, the current location information of the user can be obtained by the terminal through a base station, GPS or Wi-Fi, which will not be restricted in embodiments of the present invention. The first server can be a store server such as a cloud server.

Step S103, the first server querying a business matching the current location information of the user after receiving the business search request.

In one embodiment of the present invention, the business matching the current location information of the user generally refer to business around the user, such as businesses around the current location information of the user within a distance of 100 meters or 200 meters, which will not be restricted in embodiments of the present invention.

Step S104, the first server sending an queried server address of the business to the terminal.

Step S105, the terminal responding an operation which is aimed at the server address of the business by the user after receiving the server address of the business sent by the first server, and sending an information push request to a second server corresponding to the business.

In one embodiment of the present invention, the terminal can respond an click operation which is aimed at an address of the second server by a user and send an information push request to the second server after receiving the address of the second server sent by the first server. The second server can be a business server, and be configured to store product information customized by the business. And the product information customized by the business may include text information, picture information or voice information, which will not be restricted in embodiments of the present invention.

Step S106, the second server responding the information push request, and pushing product information customized by the business to the terminal.

It should be noted that the server address of a business and an address of the business may be the same or not, which will not be restricted in embodiments of the present invention.

In one embodiment of the present invention, the second server can respond the information push request, and push the product information customized by the business to the terminal by Hyper Text Transport Protocol (Hyper Text Transport Protocol, HTTP) to reduce network traffic, which will not be restricted in embodiments of the present invention.

In the method described as FIG. 1, a terminal can respond a business search command and send a business search request after receiving the business search command determined by an operation of a user. So that a first server such as a cloud server can query a business matching current location information of the user after receiving the business search request, and send a server address of the business to the terminal. After receiving the server address of the business sent by the cloud server, the terminal can respond an operation which is aimed at the server address of the business by the user and send an information push request to a second server corresponding to the business. The second server such as a business server can respond the information push request, and push the product information customized by the business to the terminal. In the method described as FIG. 1, it is obvious that product information can be accurately pushed to a user. In addition, a business server configured to store product information customized by the business belongs to a private server. So that the business can set up its own product information and make a real-time update for the product information, thereby improving the push effect of the product information.

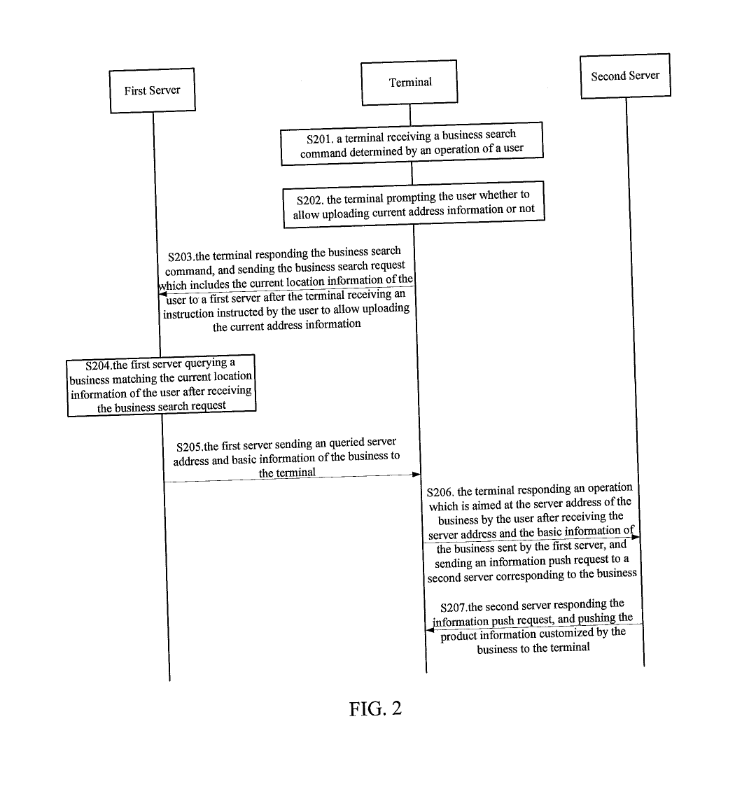

Referring to FIG. 2, it is a flowchart of a method for information push disclosed by another embodiment of the present invention. As shown in FIG. 2, the method for information push may include the following steps.

Step S201, a terminal receiving a business search command determined by an operation of a user.

In one embodiment of the present invention, the terminal may be a smart phone (such as an Android phone, an iOS mobile phone, etc), a tablet computer, a handheld computers, a mobile internet device (Mobile Internet Device , MID) or other mobile terminal, and can also be a PC, which will not be restricted in embodiments of the present invention.

In one embodiment, the terminal can receive the business search command input by the user when operating a business search interface on in an instant messaging tool, such as a business search interface on a business search plugin or some other information platforms. Specifically, the user can click to enter a plugin interface of the instant messaging tool after using an instant messaging account to login the instant messaging tool on the terminal. Furthermore, the user may single-click or double-click the business search plugin on the plugin interface of the instant messaging tool, thereby triggering to input a business search command to the terminal. Embodiments of the present invention can be combined with massive users in the instant messaging tool, business information around a user can be provided for the user in the instant messaging tool, and at the same time, a product push channel with low-cost but high-precision will be provided for the businesses.

Step S202, the terminal prompting the user whether to allow uploading current address information or not.

In one embodiment of the present invention, the terminal can prompt the user whether to allow uploading current address information or not by a text or voice mode, which will not be restricted in embodiments of the present invention.

Step S203, the terminal responding the business search command, and sending the business search request which includes the current location information of the user to a first server after the terminal receiving an instruction instructed by the user to allow uploading the current address information.

In one embodiment of the present invention, the current location information of the user can be obtained by the terminal through a base station, GPS or Wi-Fi, which will not be restricted in embodiments of the present invention. The first server can be a store server such as a cloud server.

In one embodiment of the present invention, before receiving the instruction to allow uploading the current address information, the terminal may be without any operations.

Step S204, the first server querying a business matching the current location information of the user after receiving the business search request.

In one embodiment of the present invention, the businesses matching the current location information of the user generally refer to businesses around the user such as businesses around the current location information of the user within a distance of 300 meters or 500 meters, which will not be restricted in embodiments of the present invention.

Step S205, the first server sending an queried server address and basic information of the business to the terminal.

Step S206, the terminal responding an operation which is aimed at the server address of the business by the user after receiving the server address and the basic information of the business sent by the first server, and sending an information push request to a second server corresponding to the business.

Wherein the second server such as business server is configured to store product information customized by the business, the basic information of the business includes name, address and introduction of the business, and so on.

In one embodiment of the present invention, the cloud server may prestore address of each business server and basic information of each business, wherein the address of each business server and the basic information of each business can be reported to the cloud server by each business.

In one embodiment of the present invention, the terminal can view basic information of a business after receiving the server address and the basic information of the business sent by the cloud server. If interested in the business, the user can perform a click operation which is aimed at the server address of the business, thereby sending an information push request to the business server.

Step S207, the second server responding the information push request, and pushing the product information customized by the business to the terminal.

It should be noted that the server address of a business and an address of the business may be the same or not, which will not be restricted in embodiments of the present invention.

In one embodiment of the present invention, the second server can respond the information push request, and push the product information customized by the business to the terminal by HTTP to reduce network traffic, which will not be restricted in embodiments of the present invention.

In the method described as FIG. 2, a terminal can prompt the user whether to allow uploading current address information or not after receiving the business search command input by a user. If an instruction input by the user to allow uploading the current address information is received, the terminal can respond the business search command and send a business search request to a first server such as a cloud server, wherein the business search request includes the current location information of the user. So that the cloud server can query a business matching current location information of the user after receiving the business search request, and send a server address of the business as well as basic information of the business to the terminal. After receiving the server address as well as the basic information of the business sent by the cloud server, the terminal can respond an operation which is aimed at the server address of the business by the user and send an information push request to a second server corresponding to the business. The second server such as a business server can respond the information push request, and push the product information customized by the business to the terminal. In the method described as FIG. 2, it is obvious that product information can be accurately pushed to a user. In addition, a business server configured to store product information customized by the business belongs to a private server. So that the business can set up its own product information and make a real-time update for the product information, thereby improving the push effect of the product information.

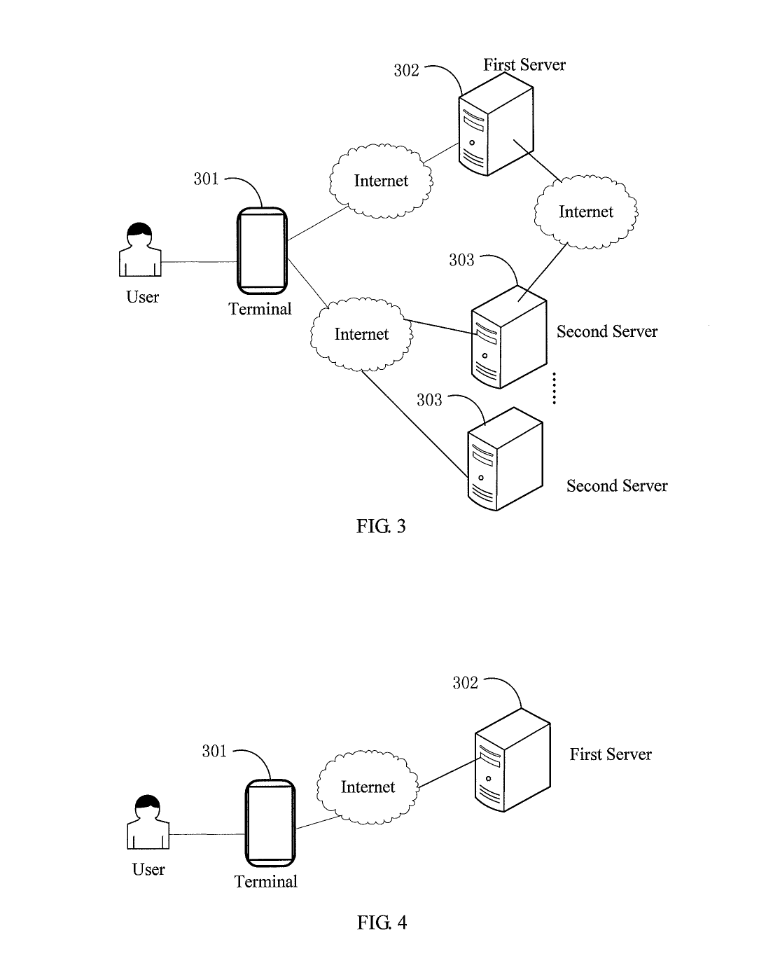

Referring to FIG. 3, it is a structure diagram of a system for information push disclosed by one embodiment of the present invention. As shown in FIG. 3, the system for information push may include a terminal 301, a first server 302 and a second server 303, wherein the terminal 301 is connected with the first server 302 and the second server 303 via the Internet, wherein

the terminal 301 is configured to receive a business search command determined by an operation of a user, respond the business search command, and send a business search request which includes current location information of the user to a first server 302;

the first server 302 is configured to query a business matching the current location information of the user after receiving the business search request, and send a server address of the business to the terminal;

the terminal 301 is further configured to respond an operation which is aimed at the server address of the business by the user after receiving the server address of the business sent by the first server 302, sending an information push request to a second server 303 corresponding to the business, wherein the second server 303 is configured to store product information customized by the business; and

the second server 303 is configured to respond the information push request, and push the product information customized by the business to the terminal 301.

In one embodiment, the terminal 301 is further configured to prompt the user whether to allow uploading current address information or not after receiving the business search command determined by the operation of the user, and before the terminal 301 responding the business search command, and sending the business search request which includes the current location information of the user to the first server, if an instruction instructed by the user to allow uploading the current address information is received, the terminal 301 performing the step of responding the business search command, and sending the business search request which includes current location information of the user to the first server. The terminal 301 can prompt the user whether to allow uploading current address information or not by a text or voice mode, which will not be restricted in embodiments of the present invention.

In one embodiment of the present invention, the first server 302 is further configured to send basic information of a business to the terminal 301, wherein the business matches the current location information of the user, and the basic information of the business includes name, address and introduction of the business.

Accordingly, the terminal 301 is further configured to receive the basic information of the business sent by the first server.

In one embodiment of the present invention, the terminal 301 can view basic information of a business after receiving the address of the second server and the basic information of the business sent by the first server. If interested in the business, the user can perform a click operation which is aimed at the server address of the business and an information push request can be sent to the second server 303 by the terminal 301.

In one embodiment of the present invention, the first server 302 may prestore address of each second server and basic information of each business, wherein the address of each second server and the basic information of each business can be reported to the first server 302 by each business.

In one embodiment of the present invention, the way of the terminal 301 receiving the business search command input by the user may be specifically for: the terminal 301 is configured to receive the business search command input by the user when operating a business search interface on in an instant messaging tool, such as a business search interface on a business search plugin or some other information platforms. Specifically, the user can click to enter a plugin interface of the instant messaging tool after using an instant messaging account to login the instant messaging tool on the terminal 301. Furthermore, the user may single-click or double-click the business search plugin on the plugin interface of the instant messaging tool, thereby triggering to input a business search command to the terminal 301. Embodiments of the present invention can be combined with massive users in the instant messaging tool, business information around a user can be provided for the user in the instant messaging tool, and at the same time, a product push channel with low-cost but high-precision will be provided for the businesses.

In one embodiment of the present invention, the way of the second server 303 responding the information push request, and pushing the product information customized by the business to the terminal 301 may be specifically for: the second server 303 is configured to respond the information push request, and push the product information customized by the business to the terminal 301 by HTTP, thus the network traffic can be reduced.

It should be noted that the server address of a business and an address of the business may be the same or not, which will not be restricted in embodiments of the present invention.

Referring to FIG. 4, it is a structure diagram of a system for information push disclosed by another embodiment of the present invention. As shown in FIG. 3, the system for information push may include the terminal 301 and the first server 302, wherein

the terminal 301 can receive a business search command determined by an operation of a user, respond the business search command, and send a business search request which comprises current location information of the user to the first server 303 via the Internet, and the first server can be a cloud server;

the first server 302 can query a business matching the current location information of the user, send information of the business to the terminal after receiving the business search request.

In one embodiment, the information of the business may include name, address and introduction of the business, which will not be restricted in embodiments of the present invention. The first server 302 can be a store server such as a cloud server, the cloud server stores the information of the business. Furthermore, the first server 302 can also be a business server, the user can obtain the information of the business through the business server directly.

In the system for information push disclosed by the embodiment of the present invention, product information can be accurately pushed to a user. In addition, a business server configured to store product information customized by the business belongs to a private server. So that the business can set up its own product information and make a real-time update for the product information, thereby improving the push effect of the product information.

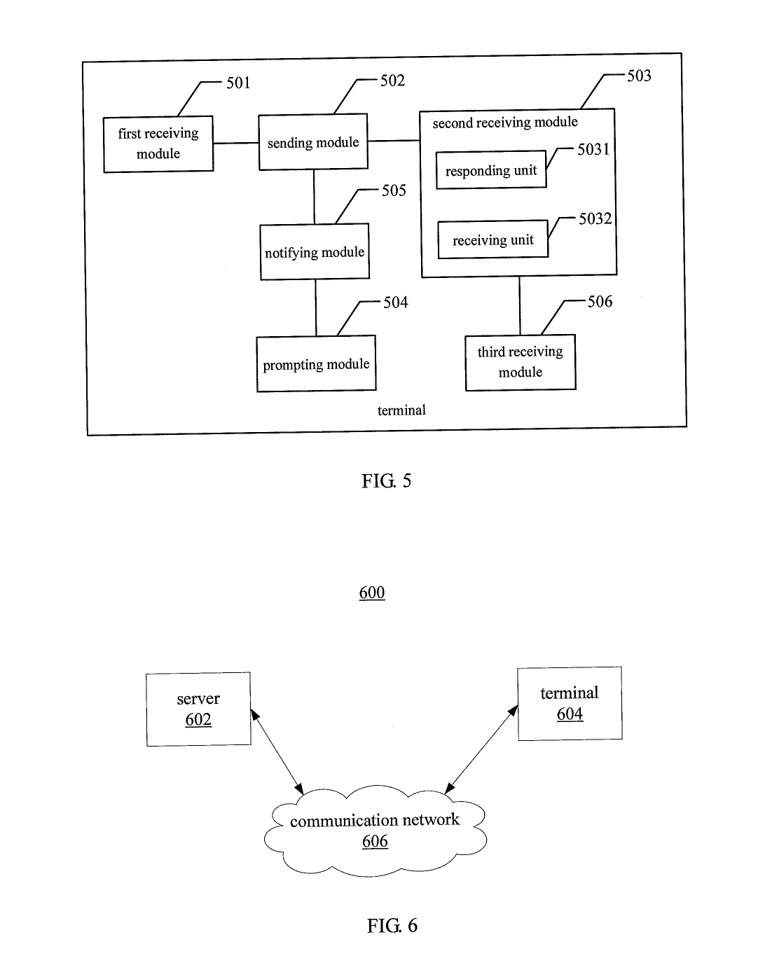

Referring to FIG. 5, it is a structure diagram of a terminal disclosed by one embodiment of the present invention. As shown in FIG. 5, the terminal including:

a first receiving module 501, which is configured to receive a business search command determined by an operation of a user;

a sending module 502, which is configured to respond the business search command received by the first receiving module, and send a business search request which comprises current location information of the user to a first server to query a business matching the current location information of the user;

a second receiving module 503, which is configured to receive information of the business in response to the business search request returned by the first server.

In one embodiment of the present invention, the terminal may be a smart phone (such as an Android phone, an iOS mobile phone, etc), a tablet computer, a handheld computers, a mobile Internet device (Mobile Internet Device, MID) or other mobile terminal, and can also be a PC, which will not be restricted in embodiments of the present invention.

In one embodiment, the first receiving module 501 can receive the business search command input by the user when operating a business search interface on in an instant messaging tool, such as a business search interface on a business search plugin or some other information platforms.

In one embodiment of the present invention, the current location information of the user can be obtained by the terminal through a base station, GPS or Wi-Fi, which will not be restricted in embodiments of the present invention. The first server can be a business server, and the second server can be a cloud server.

In one embodiment of the present invention, the second receiving module 503 may include:

a responding unit 5031, which is configured to receive a server address of the business in response to the business search request returned by the first server, respond an operation which is aimed at the server address of the business by the user, and send an information push request to a second server corresponding to the business, wherein the second server is configured to store product information customized by the business;

a receiving unit 5032, which is configured to receive the product information customized by the business in response to the information push request returned by the second server.

In one embodiment, the first server can be a cloud server, the second server can be a business server, and the second server is configured to store product information customized by the business. The product information customized by the business may include text information, picture information or voice information, which will not be restricted in embodiments of the present invention.

In one embodiment of the present invention, the first server can respond the information push request, and push the product information customized by the business to the terminal by Hyper Text Transport Protocol (Hyper Text Transport Protocol, HTTP) to reduce network traffic, which will not be restricted in embodiments of the present invention. The second receiving module 504 can receive the product information by HTTP.

In one embodiment of the present invention, the terminal further including:

a prompting module 504, which is configured to prompt the user whether to allow uploading current address information or not;

a notifying module 505, which is configured to notify the sending module 502 to respond the business search command, if an instruction instructed by the user to allow uploading the current address information is received, and send the business search request which comprises the current location information of the user to the first server;

a third receiving module 506, which is configured to receive basic information of a business sent by the first server, wherein the business matches the current location information of the user, and the basic information of the business includes name, address and introduction of the business.

In one embodiment of the present invention, it is obvious that product information can be accurately pushed to a user. In addition, a business server configured to store product information customized by the business belongs to a private server. So that the business can set up its own product information and make a real-time update for the product information, thereby improving the push effect of the product information.

The methods and systems in accordance with various embodiments can be accomplished using a program/software to instruct related hardware. The hardware can include any suitable universal hardware, or any suitable specialized hardware including, e.g., specialized integrated circuits, specialized central processing unit (CPU), specialized memory, specialized components, etc. For example, the hardware can include personal computer, server, network device, etc. The program/software can be stored in a computer-readable storage medium including, e.g., ROM/RAM, magnetic disk, optical disk, etc.

The embodiments described above are merely preferred ones of the present disclosure but are not limitations to the protection scope of the present disclosure, and any variations or substitutions easily devised by those skilled in the art without departing from the spirit of the present disclosure fall within the scope of the protection. Therefore, the protection scope of the present disclosure shall be subject to that specified by the appended claims.

1. A method for information push, comprising:
receiving a business search command determined by an operation of a user;
responding the business search command, and sending a business search request which comprises current location information of the user to a first server to query a business matching the current location information of the user; and
receiving information of the business in response to the business search request returned by the first server.

2. The method for information push according to claim 1, wherein the step of receiving the information of the business in response to the business search request returned by the first server comprises:
receiving a server address of the business in response to the business search request returned by the first server, responding an operation which is aimed at the server address of the business by the user, and sending an information push request to a second server corresponding to the business, wherein the second server is configured to store product information customized by the business;
receiving the product information customized by the business in response to the information push request returned by the second server.

3. The method for information push according to claim 1, after receiving the business search command determined by the operation of the user, and before responding the business search command, and sending the business search request which comprises the current location information of the user to the first server, the method further comprising:
prompting the user whether to allow uploading current address information or not;
if an instruction instructed by the user to allow uploading the current address information is received, performing the step of responding the business search command, and sending the business search request which comprises the current location information of the user to the first server.

4. The method for information push according to claim 1, after responding the business search command, and sending the business search request which comprises the current location information of the user to the first server, the method further comprising:
receiving basic information of a business sent by the first server, wherein the business matches the current location information of the user, and the basic information of the business comprises name, address and introduction of the business.

5. The method for information push according to claim 1, wherein the step of receiving the business search command determined by the operation of the user comprises:
receiving the business search command input by a user when operating a business search interface on an instant messaging tool.

6. The method for information push according to claim 2, wherein the step of receiving the product information customized by the business in response to the information push request returned by the second server, comprises:
receiving the product information customized by the business in response to the information push request and sent by Hypertext Transfer Protocol (HTTP).

7. The method for information push according to claim 2, wherein
the product information customized by the business comprises any one or more of text information, picture information, and voice information.

8. A terminal, comprising:
memory;
one or more processors; and
one or more modules stored in the memory and configured for execution by the one or more processors, the one or more modules including instructions:
to receive a business search command determined by an operation of a user;
to respond the business search command received by the first receiving module, and send a business search request which comprises current location information of the user to a first server to query a business matching the current location information of the user;
to receive information of the business in response to the business search request returned by the first server.

9. The terminal to claim 8, wherein the one or more modules further comprises instructions:
to receive a server address of the business in response to the business search request returned by the first server, respond an operation which is aimed at the server address of the business by the user, and send an information push request to a second server corresponding to the business, wherein the second server is configured to store product information customized by the business;
to receive the product information customized by the business in response to the information push request returned by the second server.

10. The terminal according to claim 8, wherein the one or more modules further comprises instructions:
to prompt the user whether to allow uploading current address information or not;
to notify the sending module to respond the business search command, if an instruction instructed by the user to allow uploading the current address information is received, and send the business search request which comprises the current location information of the user to the first server.

11. The terminal according to claim 8, wherein the one or more modules further comprises instructions:
to receive basic information of a business sent by the first server, wherein the business matches the current location information of the user, and the basic information of the business comprises name, address and introduction of the business.

12. The terminal according to claim 8, wherein the one or more modules further comprises instructions:
to receive the business search command input by a user when operating a business search interface on an instant messaging tool.

13. The terminal according to claim 9, wherein the one or more modules further comprises instructions:
to receive the product information customized by the business in response to the information push request and sent by Hypertext Transfer Protocol (HTTP).

14. The terminal according to claim 9, wherein the one or more modules further comprises instructions:
the product information customized by the business comprises any one or more of text information, picture information, voice information.

15. A system for information push, comprising a terminal, a first server and a second server, wherein:
the terminal is configured to receive a business search command determined by an operation of a user, respond the business search command, and send a business search request which comprises current location information of the user to a first server;
the first server is configured to query a business matching the current location information of the user after receiving the business search request, and send a server address of the business to the terminal;
the terminal is further configured to respond an operation which is aimed at the server address of the business by the user after receiving the server address of the business sent by the first server, sending an information push request to a second server corresponding to the business, wherein the second server is configured to store product information customized by the business; and
the second server is configured to respond the information push request, and push the product information customized by the business to the terminal.

16. The system for information push according to claim 15, wherein:
the terminal is further configured to prompt the user whether to allow uploading current address information or not after receiving the business search command determined by the operation of the user, and before the terminal responding the business search command, and sending the business search request which comprises the current location information of the user to the first server; if an instruction instructed by the user to allow uploading the current address information is received, the terminal performing the step of responding the business search command, and sending the business search request which comprises the current location information of the user to the first server.

17. The system for information push according to claim 15, wherein:
the first server is further configured to send basic information of a business to the terminal, wherein the business matches the current location information of the user, and the basic information of the business comprises name, address and introduction of the business;
the terminal is further configured to receive the basic information of the business sent by the first server.

18. The system for information push according to claim 15, wherein the terminal receiving the business search command determined by the operation of the user is by:
the terminal receiving the business search command input by a user when operating a business search interface on an instant messaging tool.

19. The system for information push according to claim 15, wherein the second server responding the information push request, and pushing the product information customized by the business to the terminal is by:
the second server responding the information push request, and pushing the product information customized by the business to the terminal by Hypertext Transfer Protocol (HTTP).

20. (canceled)

21. The method for information push according to claim 2, after receiving the business search command determined by the operation of the user, and before responding the business search command, and sending the business search request which comprises the current location information of the user to the first server, the method further comprising:
prompting the user whether to allow uploading current address information or not;
if an instruction instructed by the user to allow uploading the current address information is received, performing the step of responding the business search command, and sending the business search request which comprises the current location information of the user to the first server.
